(19) United States
(12) Patent Application Publication
(10) Pub. No.: US 2025/0142676 A1
(43) Pub. Date: May 1, 2025

(54) LIQUID EJECTING HEAD AND LIQUID EJECTING APPARATUS

(71) Applicant: SEIKO EPSON CORPORATION, Tokyo (JP)

(72) Inventors: Haruhisa UEZAWA, SHIOJIRI-SHI (JP); Masahiko SATO, AZUMINO-SHI (JP)

(21) Appl. No.: 18/929,024

(22) Filed: Oct. 28, 2024

(30) Foreign Application Priority Data
Oct. 30, 2023 (JP) 2023-185531

(51) Int. Cl. H05B 3/26; B41J 2/005; B41J 2/15

(52) U.S. Cl. CPC H05B 3/26; B41J 2/15; B41J 2002/0055; H05B 2203/016

(57) ABSTRACT

A liquid ejecting head includes: a nozzle; and a sheet-shaped heater for heating the liquid to be supplied to the nozzle, and the heater includes a main surface portion having a temperature detection element, an insulative first base member having a first surface and a second surface on an opposite side of the first surface, a resistance wire disposed on the first surface and configured to heat a heating target being a portion of the liquid ejecting head, and relay wiring electrically connected to the temperature detection element and disposed on the second surface, and the resistance wire overlaps the relay wiring when viewed in a thickness direction of the main surface portion.

The present application is based on, and claims priority from JP Application Serial Number 2023-185531, filed Oct. 30, 2023, the disclosure of which is hereby incorporated by reference herein in its entirety.

### BACKGROUND

### 1. Technical Field

The present disclosure relates to a liquid ejecting head that ejects a liquid from a nozzle, and to a liquid ejecting apparatus.

### 2. Related Art

As represented by an ink jet printer, there has heretofore been known a liquid ejecting apparatus including a liquid ejecting head that ejects a liquid such as an ink.

There has been known a liquid ejecting head including a sheet-shaped heater for heating a liquid to be ejected (see JP-A-11-10862, for example). In the sheet-shaped heater, a resistance wire serving as a heating wire and relay wiring connected to a temperature sensor for detecting a temperature are disposed on the same surface.

However, when the resistance wire and the relay wiring are disposed on the same surface of the heater, a space is required for routing the relay wiring in such a way as to bypass the resistance wire. Accordingly, there is a problem of a possible increase in size of the heater.

### SUMMARY

An aspect according to the present disclosure to solve the above-mentioned problem is a liquid ejecting head including: a nozzle that ejects a liquid; and a sheet-shaped heater for heating the liquid to be supplied to the nozzle, and the heater includes a main surface portion having a temperature detection element, an insulative first base member having a first surface and a second surface on an opposite side of the first surface, a resistance wire disposed on the first surface and configured to heat a heating target being a portion of the liquid ejecting head, and relay wiring electrically connected to the temperature detection element and disposed on the second surface, and the resistance wire overlaps the relay wiring when viewed in a thickness direction of the main surface portion.

Another aspect of the present disclosure is a liquid ejecting apparatus including: the liquid ejecting head according to above-mentioned aspect; and a liquid reservoir that reserves the liquid to be supplied to the liquid ejecting head.

### BRIEF DESCRIPTION OF THE DRAWINGS

FIG. 1 is a diagram illustrating a schematic configuration of a liquid ejecting apparatus according to Embodiment 1.

FIG. 2 is an exploded perspective view of a liquid ejecting head according to the Embodiment 1.

FIG. 3 is a cross-sectional view of the liquid ejecting head according to the Embodiment 1.

FIG. 4 is a plan view of a holder according to the Embodiment 1.

FIG. 5 is a cross-sectional view of a head chip according to the Embodiment 1.

FIG. 6 is a cross-sectional view of a heater according to the Embodiment 1.

FIG. 7 is a plan view of the heater according to the Embodiment 1.

FIG. 8 is a plan view of a modified example of the heater according to the Embodiment 1.

FIG. 9 is a schematic configuration diagram illustrating the heaters and a relay substrate according to the Embodiment 1.

FIG. 10 is a schematic configuration diagram illustrating a modified example of the heaters and the relay substrate according to the Embodiment 1.

### DESCRIPTION OF EMBODIMENTS

The present disclosure will be described below in detail based on an embodiment. It is to be noted, however, that the following description is intended to represent one aspect of the present disclosure, which can be arbitrarily modified within the scope of the present disclosure. Constituents designated by the same reference signs in the respective drawings represent the same constituents, and explanations thereof are omitted as appropriate. In the meantime, x, y, and z in the respective drawings represent three spatial axes that are orthogonal to one another. In the present specification, directions along these axes will be defined as x direction, y direction, and z direction, respectively. Each direction in the respective drawings to which an arrow is oriented will be explained as a positive (+) direction and a direction opposite to the arrow will be explained as a negative (−) direction. Meanwhile, the directions along the three spatial axes without specifying the positive direction or the negative direction will be explained as x axis direction, y axis direction, and z axis direction, respectively. Moreover, a view along the z axis direction will be referred to as “plan view”.

### Embodiment 1

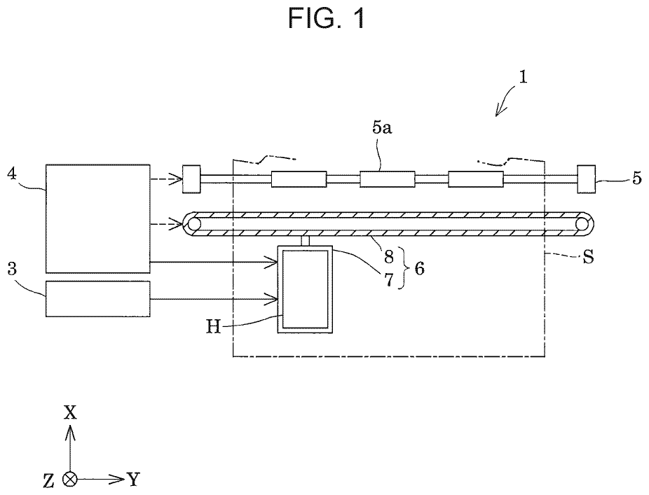

FIG. 1 is a diagram illustrating a schematic configuration of a liquid ejecting apparatus 1 according to Embodiment 1 of the present disclosure.

As illustrated in FIG. 1, the liquid ejecting apparatus 1 is a so-called serial printer which includes a liquid ejecting head H and performs printing by ejecting liquids in the +z direction from the liquid ejecting head H toward a medium S while transporting the medium S in the x axis direction and reciprocating the liquid ejecting head H in the y axis direction. As for the medium S, it is possible to use an arbitrary material such as cloth, printing paper, and a resin film.

The above-mentioned liquid ejecting apparatus 1 includes the liquid ejecting head H, a liquid reservoir 3, a control unit 4 being a controller, a transportation mechanism 5 that feeds the medium S, and a movement mechanism 6.

The liquid ejecting head H ejects the liquids supplied from the liquid reservoir 3 reserving the liquids in the +z direction as liquid droplets.

The liquid reservoir 3 individually reserves multiple types of liquids having different colors or different components to be ejected from the liquid ejecting head H. Examples of the liquid reservoir 3 include a cartridge that is attachable to and detachable from the liquid ejecting apparatus 1, an ink package in the form of a bag formed from a flexible film, an ink tank that is ink-refillable, and the like. FIG. 1 illustrates a single liquid reservoir 3 as an example. Incidentally, the liquid reservoir 3 may be a liquid reservoir 3 provided with chambers that are divided for individually reserving the multiple types of liquids, or may be formed from two or more liquid reservoirs 3 that are individually provided so as to correspond to the multiple types of liquids. Meanwhile, the liquid reservoir 3 may be divided into a main tank and a sub-tank. This liquid reservoir 3 may be configured to connect the sub-tank to the liquid ejecting head H and to refill the sub-tank with the liquid in the main tank in an amount equivalent to that consumed in the course of ejection of the liquid droplets from the liquid ejecting head H.

The control unit 4 conducts integrated control over the respective elements of the liquid ejecting apparatus 1, namely, the liquid ejecting head H, the transportation mechanism 5, the movement mechanism 6, and so forth.

The transportation mechanism 5 is configured to transport the medium S in the x axis direction and is provided with a transportation roller 5a. The transportation mechanism 5 transports the medium S in the x axis direction by rotating the transportation roller 5a. The transportation roller 5a is rotated by driving a not-illustrated transportation motor. The control unit 4 controls the transportation of the medium S by controlling the drive of the transportation motor. Note that the transportation mechanism 5 that transports the medium S is not limited to the one provided with the transportation roller 5a but may be configured to transport the medium S by using a belt, a drum, and the like, for example.

The movement mechanism 6 is a mechanism for reciprocating the liquid ejecting head H in the y axis direction, and includes a holding body 7 and a transportation belt 8. The holding body 7 is a so-called carriage that holds the liquid ejecting head H, which is fixed to the transportation belt 8. The transportation belt 8 is an endless belt stretched along the y axis direction. The transportation belt 8 is rotated by driving the not-illustrated transportation motor. The control unit 4 rotates the transportation belt 8 by controlling the drive of the transportation motor, thereby reciprocating the liquid ejecting head H in the y axis direction together with the holding body 7. Here, the holding body 7 may be designed to mount the liquid reservoir 3 together with the liquid ejecting head H.

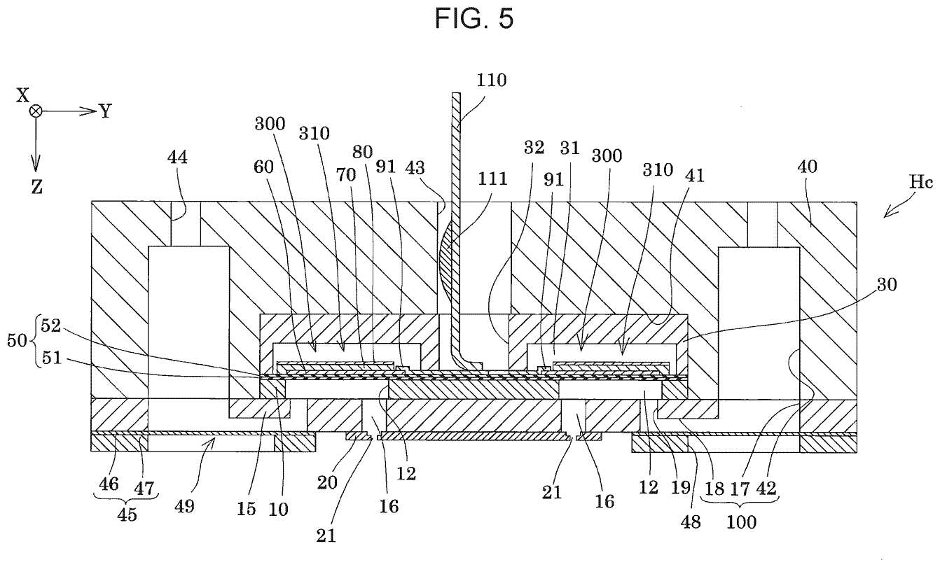

Under control by the control unit 4, the liquid ejecting head H executes an ejecting action to eject the liquids supplied from the liquid reservoir 3 from respective nozzles 21 (see FIG. 5) in the +z direction as the liquid droplets. This ejecting action by the liquid ejecting head H is carried out in parallel with the transportation of the medium S by the transportation mechanism 5 and the reciprocation of the liquid ejecting head H by the movement mechanism 6. Thus, application of the liquids onto the medium S, or so-called printing is carried out.

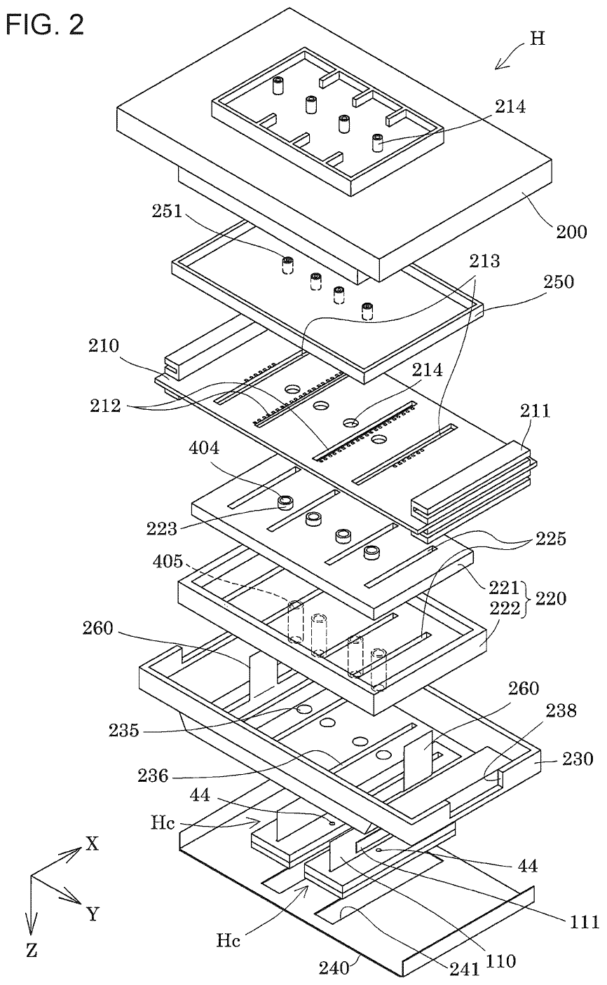

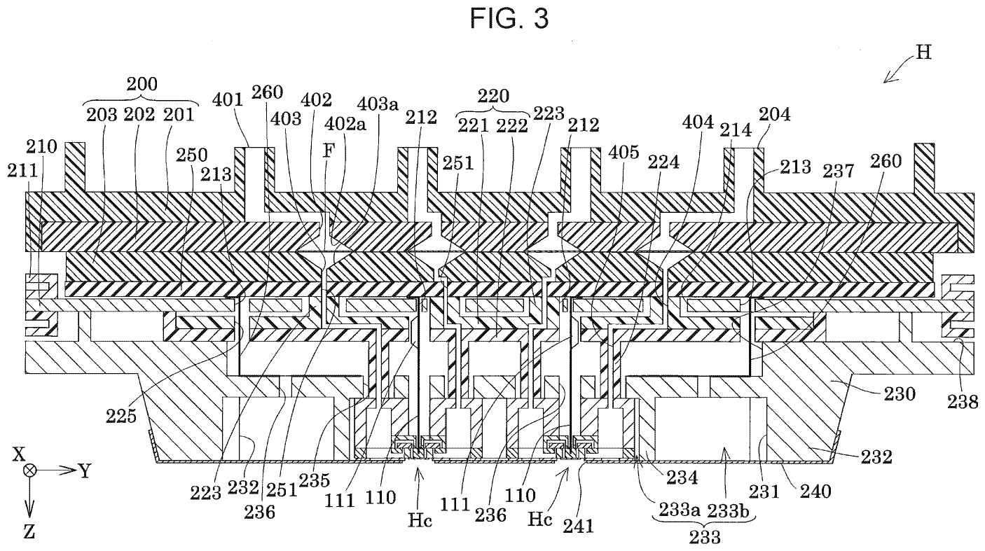

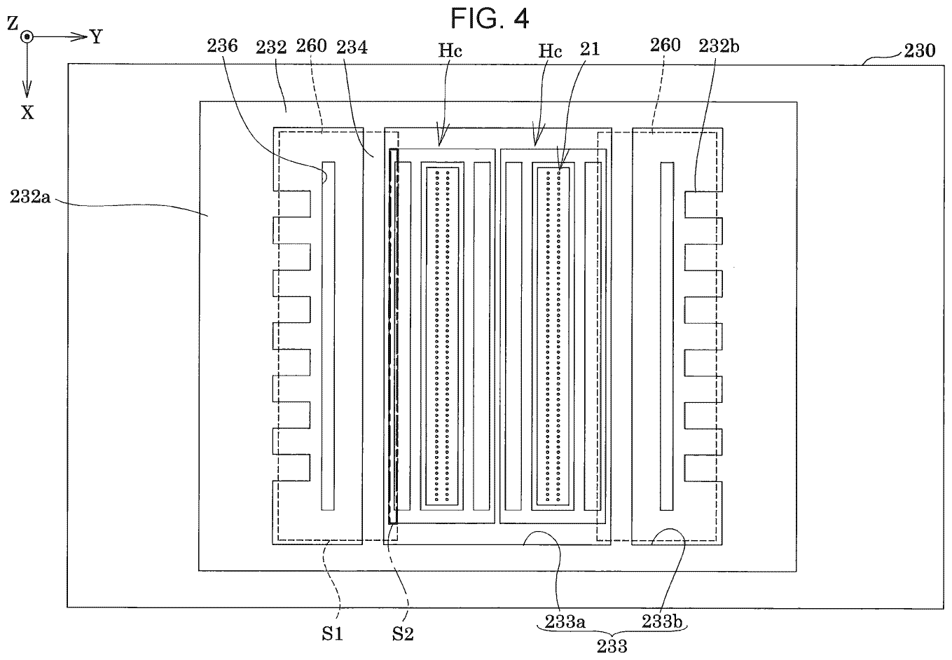

FIG. 2 is an exploded perspective view of the liquid ejecting head H. FIG. 3 is a cross-sectional view of the liquid ejecting head H. FIG. 4 is a plan view of a holder 230 viewed in the −z direction. Here, directions of the liquid ejecting head H will be described based on directions when the liquid ejecting head H is mounted on the liquid ejecting apparatus 1, namely, the x axis direction, the y axis direction, and the z axis direction, respectively.

As illustrated in these drawings, the liquid ejecting head H includes head chips Hc, which are two in the present embodiment, a first flow channel unit 200, a relay substrate 210, a second flow channel unit 220, the holder 230, a cover head 240, a sealing member 250, and heaters 260.

FIG. 5 is a cross-sectional view illustrating an example of the head chip Hc. Here, directions of the head chip Hc will be described based on directions when the head chip Hc is mounted on the liquid ejecting head H, namely, the x axis direction, the y axis direction, and the z axis direction, respectively.

As illustrated in FIG. 5, the head chip Hc includes a flow channel formation substrate 10, a communication plate 15, a nozzle plate 20 provided with the nozzles 21, a protection substrate 30, a case member 40, piezoelectric actuators 300, and a first flexible substrate 110.

The flow channel formation substrate 10 is formed from any of a silicon substrate, a glass substrate, an SOI substrate, and various ceramic substrates, for example. Pressure chambers 12 are disposed in the flow channel formation substrate 10 in arrangement along the x axis direction. The pressure chambers 12 are disposed on a straight line along the x axis direction so as to be located at the same position concerning the y axis direction. In the present embodiment, two pressure chamber lines each formed by arranging the pressure chambers 12 along the x axis direction are provided in the y axis direction. The respective pressure chambers 12 constituting these two pressure chamber lines are disposed at the same positions in the x axis direction. Here, the two pressure chamber lines may be disposed in a displaced manner by a half of pitches of the pressure chambers 12 from one another, or by a so-called half pitch in the x axis direction. In other words, all the pressure chambers 12 of the two pressure chamber lines may be disposed in a staggered manner along the x axis direction.

The communication plate 15 and the nozzle plate 20 are sequentially laminated on a surface of the flow channel formation substrate 10 oriented to the +z direction. Vibration plates 50 and the piezoelectric actuators 300 are sequentially laminated on a surface of the flow channel formation substrate 10 oriented to the −z direction.

The communication plate 15 is formed from a plate member joined to the surface oriented to the +z direction of the flow channel formation substrate 10. The communication plate 15 is provided with nozzle communication channels 16 each of which establishes communication between each pressure chamber 12 and the corresponding nozzle 21. Moreover, the communication plate 15 is provided with a first manifold portion 17 and a second manifold portion 18 each constituting part of a manifold 100 that forms a common liquid chamber with which the pressure chambers 12 communicate in common. The first manifold portion 17 is provided to penetrate the communication plate 15 in the z axis direction. Meanwhile, the second manifold portion 18 is provided in such a way as to be open to the surface oriented to the +z direction without penetrating the communication plate 15 in the z axis direction. In addition, the communication plate 15 includes supply communication channels 19 to communicate with the pressure chambers 12, which are independently provided to the respective pressure chambers 12. Each supply communication channel 19 establishes communication between the second manifold portion 18 and the corresponding pressure chamber 12, thereby supplying the ink in the manifold 100 to the pressure chamber 12. The above-described communication plate 15 employs any of a silicon substrate, a glass substrate, an SOI substrate, various ceramic substrates, a metal substrate such as a stainless steel substrate, and so forth.

The nozzle plate 20 is joined to the surface of the communication plate 15 on the opposite side of the flow channel formation substrate 10, or in other words, to the surface oriented to the +z direction. The nozzle plate 20 is provided with the nozzles 21 that communicate with the respective pressure chambers 12 through the nozzle communication channels 16. In the present embodiment, the nozzles 21 are disposed in such a way as to be arranged in a line along the x axis direction for each of the pressure chamber lines. That is to say, in the present embodiment, two nozzle lines each including the nozzles 21 arranged along the x axis direction are disposed away from each other in the y axis direction. The respective nozzles 21 constituting these two nozzle lines are disposed in such a way as to be located at the same positions as one another in the x axis direction. Of course, in the case where the pressure chambers 12 in the two pressure chamber lines are disposed at the positions displaced from one another by the half pitch, the two nozzle lines may also be disposed in such a way as to be displaced by the half pitch from one another in the x axis direction. That is to say, all the nozzles 21 in the two nozzle lines may be disposed in a staggered manner along the x axis direction.

The above-described nozzle plate 20 employs any of a silicon substrate, a glass substrate, an SOI substrate, various ceramic substrates, a metal substrate such as a stainless steel substrate, organic substances such as polyimide resin, and so forth. A surface of the nozzle plate 20 oriented to the +z direction constitutes part of an ejection surface of the liquid ejecting head H.

In the present embodiment, each vibration plate 50 includes an elastic film 51 provided on the flow channel formation substrate 10 side and made of silicon oxide, and an insulating film 52 provided on a surface of the elastic film 51 oriented to the −z direction and made of zirconium oxide. Here, the vibration plate 50 may consist of the elastic film 51, consist of the insulating film 52, or adopt a structure including another film in addition to the elastic film 51 and the insulating film 52.

Each piezoelectric actuator 300 includes a first electrode 60, a piezoelectric layer 70, and a second electrode 80, which are sequentially laminated toward the −z direction on the vibration plate 50. The above-mentioned piezoelectric actuator 300 is also referred to as a piezoelectric element, which corresponds to a portion including the first electrode 60, the piezoelectric layer 70, and the second electrode 80. Meanwhile, a portion of the piezoelectric layer 70 where piezoelectric strain occurs in a case of applying a voltage between the first electrode 60 and the second electrode 80 will be referred to as an activated portion 310. Specifically, the activated portion 310 corresponds to the portion of the piezoelectric layer 70 interposed between the first electrode 60 and the second electrode 80. In the present embodiment, the activated portion 310 is provided to each of the pressure chambers 12. These activated portions 310 serve as “drive elements” that create changes in pressure of inks inside the pressure chambers 12. Moreover, one of electrodes of each activated portion 310 is formed as an individual electrode that is independent to each activated portion 310 while the other electrode is formed as a common electrode that is common to the activated portions 310. In the present embodiment, the first electrodes 60 are divided corresponding to the respective activated portions 310 and constitute the individual electrodes of the activated portions 310, while the second electrode 80 is provided continuously across the activated portions 310 so as to form the common electrode to the activated portions 310. Of course, the first electrode 60 may form the common electrode and the second electrode 80 may form the individual electrode instead.

The piezoelectric layer 70 is formed by using a piezoelectric material made of a compound oxide having a perovskite structure expressed by a general formula ABO₃, for example.

Meanwhile, an individual lead electrode 91 serving as lead-out wiring is led out of each first electrode 60. Meanwhile, a common lead electrode serving as not-illustrated lead-out wiring is led out of the second electrode 80. The first flexible substrate 110 having flexibility is connected to end portions of these individual lead electrodes 91 and of the common lead electrode on opposite sides of end portions thereof connected to the piezoelectric actuators 300. A drive signal selection circuit 111, which includes switching elements used for selecting whether or not to supply a drive signal COM for driving the respective activated portions 310 to each of the activated portions 310, is mounted on the first flexible substrate 110. That is to say, the first flexible substrate 110 of the present embodiment is a chip on film (COF). Here, the first flexible substrate 110 does not always have to be provided with the drive signal selection circuit 111. In other words, the first flexible substrate 110 may be any of a flexible flat cable (FFC), flexible printed circuits (FPC), and the like.

The protection substrate 30 having substantially the same size as that of the flow channel formation substrate 10 is joined to a surface of the flow channel formation substrate 10 which is oriented to the −z direction. The protection substrate 30 includes housing portions 31 being spaces for protecting the piezoelectric actuators 300. The housing portions 31 are independently provided to the two lines of the piezoelectric actuators 300 disposed in arrangement in the x axis direction, and two housing portions 31 are formed in arrangement in the y axis direction. Moreover, the protection substrate 30 is provided with a through hole 32 that penetrates the protection substrate 30 in the z axis direction at a position between the two housing portions 31 disposed in arrangement in the y axis direction. The end portions of the individual lead electrodes 91 and of the not-illustrated common lead electrode led out of the electrodes of the piezoelectric actuators 300 extend in such a way as to be exposed in this through hole 32, and the individual lead electrodes 91 and the common lead electrode are electrically connected to the first flexible substrate 110 in the through hole 32. The above-described protection substrate 30 employs any of a silicon substrate, a glass substrate, an SOI substrate, various ceramic substrates, and so forth as with the flow channel formation substrate 10, for example.

Meanwhile, the case member 40 that defines a portion of the manifold 100 communicating with the pressure chambers 12 is fixed onto the protection substrate 30. The case member 40 has substantially the same shape as that of the above-mentioned communication plate 15 in plan view, and is joined to the protection substrate 30 and to the above-mentioned communication plate 15 as well. The above-described case member 40 has a recess 41 on the protection substrate 30 side having such a depth that houses the flow channel formation substrate 10 and the protection substrate 30. Meanwhile, the case member 40 is provided with a third manifold portion 42 that communicates with the first manifold portion 17 of the communication plate 15. Moreover, the first manifold portion 17 and the second manifold portion 18 provided to the communication plate 15, and the third manifold portion 42 provided to the case member 40 collectively constitute the manifold 100 of the present embodiment. The manifold 100 is provided to each nozzle line. That is to say, each nozzle lines can eject one of inks of different types. In the meantime, the case member 40 is provided with inlet ports 44 for communicating with the manifolds 100 and supplying the inks to the respective manifolds 100. Moreover, the case member 40 is provided with a connection port 43, which communicates with the through hole 32 of the protection substrate 30 and to which the first flexible substrate 110 is inserted. The first flexible substrate 110 is led out to the surface side of the liquid ejecting head H oriented to the −z direction through the connection port 43. A metal material, a resin material, and the like can be used for the case member 40, for example.

Meanwhile, a compliance substrate 45 is provided on a surface of the communication plate 15 on the +z direction side where the first manifold portion 17 and the second manifold portion 18 are open. This compliance substrate 45 seals openings on the +z direction side of the first manifold portion 17 and of the second manifold portion 18. In the present embodiment, the above-described compliance substrate 45 includes a sealing film 46 formed from an elastic thin film, and a fixation substrate 47 formed from a hard material such as a metal. A region of the fixation substrate 47 opposed to each manifold 100 is provided with an opening 48 that is completely removed in a thickness direction, and a surface on one side of the manifold 100 is formed into a compliance portion 49 being a flexible portion sealed only with the flexible sealing film 46. Each head chip Hc is fixed to the cover head 240 by fixing a surface of the fixation substrate 47 that is oriented to the +z direction to a surface of the cover head 240 that is oriented to the −z direction by using and adhesive or the like. The cover head 240 is a common member to be fixed to the respective fixation substrates 47 of the multiple head chips Hc, which are two in the present embodiment, respectively. Accordingly, the two head chips Hc are integrated together by the cover head 240. A surface of the above-described cover head 240 oriented to the +z direction constitutes a portion of the ejection surface.

In each of the head chips Hc described above, the liquid is taken in from the inlet port 44 and the inside of the flow channel that extends from the manifold 100 to the nozzles 21 is filled with the ink. Thereafter, the vibration plates 50 as well as the piezoelectric actuators 300 are flexurally deformed by applying voltages to the respective activated portions 310 corresponding to the pressure chambers 12 in accordance with signals from the drive signal selection circuit 111. Thus, pressures of the liquid inside the pressure chambers 12 are increased and ink droplets are ejected from predetermined nozzles 21.

The first flow channel unit 200 and the second flow channel unit 220 supply the inks from the liquid reservoir 3 to the head chips Hc.

Here, in the first flow channel unit 200, a first flow channel member 201, a second flow channel member 202, and a third flow channel member 203 are laminated in this order toward the +z direction as illustrated in FIGS. 2 to 4.

The first flow channel member 201 includes first connection portions 204 to be connected to the liquid reservoir 3 that reserves the liquids. In the present embodiment, each first connection portion 204 is provided on a surface of the first flow channel member 201 oriented to the −z direction in such a way as to cylindrically project in the −z direction. The liquid reservoir 3 may be directly connected to these first connection portions 204, or may be connected thereto while interposing supply pipes such as tubes. First flow channels 401 to which the liquids from the liquid reservoir 3 are supplied are provided inside the first connection portions 204. Meanwhile, each first flow channel 401 is provided to extend along a lamination interface between the first flow channel member 201 and the second flow channel member 202. That is to say, each first flow channel 401 includes a portion formed along the z axis direction and a portion formed along a direction orthogonal to the z axis direction.

The second flow channel member 202 includes second flow channels 402 that communicate with the first flow channels 401. Each second flow channel 402 is provided along the z axis direction. Meanwhile, an end portion in the +z direction of each second flow channel 402 is provided with a first liquid retaining portion 402a, which is formed by widening an inside diameter in comparison with the remaining region.

The third flow channel member 203 includes third flow channels 403 that communicate with the second flow channels 402. Each third flow channel 403 is provided along the z axis direction. Meanwhile, an end portion in the −z direction of each third flow channel 403 is provided with a second liquid retaining portion 403a, which is formed by widening an inside diameter in comparison with the remaining region. Moreover, a filter F being disposed in such a way as to partition between the first liquid retaining portion 402a and the second liquid retaining portion 403a is provided on a lamination boundary between the second flow channel member 202 and the third flow channel member 203. The filter F captures foreign matters such as dust and bubbles contained in the inks.

Another end of the third flow channel 403 is open to a surface of the third flow channel member 203 oriented to the +z direction, and is connected to a fifth flow channel 405 of the second flow channel unit 220 in a liquid-tight state through the sealing member 250. The sealing member 250 is formed from an elastic member such as rubber, and the sealing member 250 is provided with flow channel communication paths 251 that penetrate the sealing member 250 in the z axis direction. The third flow channels 403 and fourth flow channels 404 communicate with one another through the flow channel communication paths 251.

The second flow channel unit 220 is formed by laminating a fourth flow channel member 221 and a fifth flow channel member 222 in the +z direction.

The fourth flow channel member 221 includes cylindrical second connection portions 223 which are provided on a surface oriented to the −z direction in such a way as to project in the −z direction. Each fourth flow channel 404 to which the liquid from the third flow channel 403 is supplied is provided inside the second connection portion 223. Meanwhile, the fourth flow channel 404 is provided to extend along a lamination interface between the fourth flow channel member 221 and the fifth flow channel member 222. That is to say, the fourth flow channel 404 includes a portion formed along the z axis direction and a portion formed along the direction orthogonal to the z axis direction. An end portion in the −z direction of the second connection portion 223 is inserted into a first connection portion through hole 214 provided to the relay substrate 210 to be described later in detail, and the fourth flow channel 404 is liquid-tightly connected to the third flow channel 403 of the third flow channel member 203 through the flow channel communication path 251 of the sealing member 250 in the −z direction of the relay substrate 210.

The fifth flow channel member 222 includes cylindrical third connection portions 224 which are provided on a surface oriented to the +z direction in such a way as to project in the +z direction. The fifth flow channels 405 are provided inside the third connection portions 224. An end portion in the −z direction of each fifth flow channel 405 communicates with the fourth flow channel 404, while an end portion in the +z direction thereof is inserted into a second connection portion through hole 235 of the holder 230 to be described later in detail, and communicates with the inlet port 44 of each head chip Hc inside a housing space 233 of the holder 230. That is to say, an end surface in the +z direction of the second connection portion 223 is fixed to surfaces of the case members 40 of the head chips Hc oriented to the −z direction. Examples of fixation between the second connection portion 223 and the head chips Hc include attachment using an adhesive, thermal welding, ultrasonic welding, and so forth. It is preferable to attach the second flow channel unit 220 to the head chips Hc by using an adhesive. By attaching these constituents with the adhesive as mentioned above, the fifth flow channels 405 can be liquid-lightly connected to the inlet ports 44 of the head chips Hc, thereby suppressing ink leakages.

Meanwhile, the second flow channel unit 220 is provided with first wiring insertion holes 225 that penetrate the second flow channel unit 220 in the z axis direction. The respective first flexible substrates 110 of the head chips Hc to be described later in detail, and respective lead-out wiring portions of the heaters 260 are inserted into the first wiring insertion holes 225. Accordingly, four first wiring insertion holes 225 are provided in the present embodiment.

In the present embodiment, the second flow channel unit 220 is an example of a “flow channel member” while each of the fourth flow channel 404 and the fifth flow channel 405 is an example of a “flow channel”. As illustrated in FIG. 3, the second flow channel unit 220 being the example of the “flow channel member” includes four “flow channels” formed from the fourth flow channels 404 and the fifth flow channels 405 that correspond to the four nozzle lines, respectively. However, the second flow channel unit 220 being the example of the “flow channel member” may include one “flow channel” designed to distribute and supply the liquid to the four nozzle lines instead.

The relay substrate 210 is disposed between the sealing member 250 and the second flow channel unit 220. The first flexible substrates 110 of the head chips Hc are electrically connected in common to the relay substrate 210. Meanwhile, the heaters 260 are electrically connected to the relay substrate 210. The relay substrate 210 is formed from a hard rigid substrate without flexibility, on which the illustrated wiring, electric components, and the like are mounted. In the present embodiment, a connector 211 to which not-illustrated external wiring provided outside the liquid ejecting head His connected is illustrated as an example of such an electric component. Moreover, printing signals and the like for controlling the head chips Hc are inputted from the external wiring to the relay substrate 210 through the connector 211, and are supplied from the relay substrate 210 to the respective head chips Hc. Here, an external wiring opening 238 for inserting the external wiring to be connected to the connector 211 is provided on a side wall of the holder 230 opposed to the connector 211, which will be described later in detail. The external wiring is connected to the connector 211 of the relay substrate 210, which is provided inside the holder 230, through the external wiring opening 238.

Meanwhile, the relay substrate 210 includes first through holes 212 for leading the first flexible substrates 110 of the head chips Hc out to the surface side oriented to the −z direction. Two first through holes 212 are provided in total so as to correspond one-to-one to the respective head chips Hc.

In the meantime, the relay substrate 210 includes second through holes 213 for leading lead-out wiring portions 280 of the heaters 260 to be described later in detail out to the surface side oriented to the −z direction. Two second through holes 213 are provided in total so as to correspond one-to-one to the respective heaters 260.

Note that opening areas of the first through holes 212 and the second through holes 213 are substantially equal when viewed in the z axis direction. Here, the “opening areas being substantially equal” means that a difference between the two opening areas falls within 20%. The size of each second through hole 213 is the size large enough for inserting the first flexible substrate 110.

Here, the relay substrate 210 of the present embodiment can adopt a relay substrate of substantially the same shape used for the liquid ejecting head that holds the four head chips Hc in the housing space 233. That is to say, a portion of the four first through holes 212, which are provided to the relay substrate of the liquid ejecting head that holds the four head chips Hc for allowing insertion of the four first flexible substrates 110, can be used as the second through holes 213 for allowing insertion of the heaters 260.

Meanwhile, the relay substrate 210 includes the first connection portion through holes 214 provided to penetrate the relay substrate 210 in the z axis direction. The second connection portions 223 of the second flow channel unit 220 are inserted into the −z direction side of the relay substrate 210 through the first connection portion through holes 214 and are connected to the third flow channels 403 of the first flow channel unit 200 through the flow channel communication paths 251 of the sealing member 250. That is to say, there are provided two first connection portion through holes 214 to each of the head chips Hc, or four first connection portion through holes 214 in total.

The holder 230 includes a first recess 231 that is open to a surface of the holder 230 oriented to the +z direction. The first recess 231 is defined by an outer peripheral wall portion 232. As a consequence of fixing the cover head 240 to an end surface in the +z direction of the holder 230, that is to say, to an end surface of the outer peripheral wall portion 232, the housing space 233 is defined inside by the first recess 231 and the cover head 240. The housing space 233 includes a first space 233a in which the head chips Hc are disposed, and second spaces 233b in which no head chips Hc are disposed. The first space 233a and the second spaces 233b are divided by partition wall portions 234. In the present embodiment, the first space 233a is interposed between the two second spaces 233b when viewed in the z axis direction. That is to say, the second spaces 233b are disposed on two sides in the y axis direction of the first space 233a in plan view, respectively. In the present embodiment, the first space 233a is disposed in an interposed fashion between the two second spaces 233b in the y axis direction. That is to say, each partition wall portion 234 is disposed at a location closer to the head chips Hc than a location of a portion 232a of the outer peripheral wall portion 232 is concerning the y axis direction in which the portion 232a of the outer peripheral wall portion 232, the second space 233b, and the head chips Hc are arranged. Incidentally, the portions 232a of the outer peripheral wall portion 232 are portions on two sides in the y axis direction of the outer peripheral wall portion 232. By disposing each partition wall portion 234 at the location closer to the head chips Hc than the location of the portion 232a of the outer peripheral wall portion 232 is as described above, it is possible to transfer heat, which is transferred from the heaters 260 to be described later in detail to the holder 230, efficiently to the head chips Hc through the partition wall portion 234.

Meanwhile, as illustrated in FIGS. 3 and 4, the outer peripheral wall portion 232 includes ribs 232b that project toward the partition wall portions 234. The ribs 232b project from the outer peripheral wall portion 232 toward the partition wall portions 234 along the y axis direction, and are continuously provided across the housing space 233 in the z axis direction. The ribs 232b are disposed at predetermined intervals in the y axis direction. By providing the ribs 232b as described above, it is possible to improve rigidity of the outer peripheral wall portion 232 and to suppress deformation or destruction of the holder 230. Although the ribs 232b are provided to the outer peripheral wall portion 232 in the present embodiment, the present disclosure is not limited to this configuration. The ribs 232b may be provided to the partition wall portions 234. Alternatively, the ribs 232b may be provided to both the outer peripheral wall portion 232 and the partition wall portions 234.

The head chips Hc are housed in the above-described first space 233a of the housing space 233. In the present embodiment, the two head chips Hc are housed in the single first space 233a. A surface located in the −z direction of an inner surface of the first space 233a, namely, a bottom surface of the first recess 231 is provided with second connection portion insertion holes 235 that penetrate the holder 230. Since the two head chips Hc are housed in the first space 233a, there are provided two second connection portion insertion holes 235 to each of the head chips Hc, or four second connection portion insertion holes 235 in total. Each third connection portion 224 inserted into the second connection portion through hole 235 is attached to the head chip Hc inside the first space 233a by using a not-illustrated adhesive. The adhesive for attaching the head chip Hc to the third connection portion 224 adopts an adhesive having high etching resistance against the inks such as an epoxy-based adhesive.

Meanwhile, each head chip Hc is attached to the bottom surface of the first recess 231 by using a not-illustrated adhesive. The adhesive to attach the holder 230 to the head chip Hc is formed from an ultraviolet curable adhesive, for example, which temporarily fixes the holder 230 to the head chip Hc. That is to say, by performing positioning while temporarily fixing the holder 230 to the head chip Hc with the ultraviolet curable adhesive and then duly fixing the third connection portion 224 of the second flow channel unit 220 to the head chip Hc with an adhesive, it is possible to suppress a relative displacement between the holder 230 as well as the second flow channel unit 220 with the head chip Hc, thereby suppressing ink leakage from junctions of flow channels.

The present embodiment is configured to attach the head chip Hc to the bottom surface of the first recess 231 of the holder 230. However, the present disclosure is not limited to this configuration, and the head chip Hc does not always have to be directly attached to the holder 230.

Meanwhile, the holder 230 includes second wiring insertion holes 236 which are through holes to establish communication between the housing space 233 and the −z direction of the holder 230. The first flexible substrates 110 of the head chips Hc housed in the housing space 233 are inserted into the second wiring insertion holes 236, and the first flexible substrates 110 are led out to the −z direction of the holder 230. The second wiring insertion holes 236 are provided one-to-one to the head chips Hc, that is to say, two in total. The two second wiring insertion holes 236 communicate with the first space 233a, or in other words, are disposed at positions overlapping the first space 233a where the head chips Hc are housed when viewed in the z axis direction. Here, the holder 230 of the present embodiment is formed by providing the holder designed to hold the four head chips Hc in the housing space 233 with the partition wall portions 234 and the ribs 232b. Accordingly, the second wiring insertion holes 236 are also provided at positions that communicate with the second spaces 233b, that is to say, at positions overlapping the respective second spaces 233b when viewed in the z axis direction. Of course, the second wiring insertion holes 236 communicating with the second spaces 233b need not be provided.

Meanwhile, in the present embodiment, the second wiring insertion holes 236 and the second connection portion insertion holes 235 to communicate with the first space 233a are provided independently of one another. However, the present disclosure is not limited to this configuration. The second wiring insertion holes 236 and the second connection portion insertion holes 235 may be provided in a partially continuous manner.

According to the above-described liquid ejecting head H, the inks from the liquid reservoir 3 are supplied to the head chips Hc through the first flow channel unit 200 and the second flow channel unit 220. That is to say, the holder 230 does not define the flow channels on which the inks flow.

Note that materials of the second flow channel unit 220 and of the holder 230 will be described later.

The cover head 240 is fixed to a surface of the holder 230 oriented to the +z direction, namely, an end surface in the +z direction of the outer peripheral wall portion 232 and end surfaces in the +z direction of the partition wall portions 234. The cover head 240 is formed from a metal plate of stainless steel and the like, and has such a size that covers an opening of the first recess 231 of the holder 230. The housing space 233 is defined in the first recess 231 of the holder 230 by the cover head 240. The cover head 240 is a member that is fixed in common to surfaces of the two head chips Hc oriented to the +z direction. Moreover, the cover head 240 is provided with exposure openings 241 that expose the nozzles 21 of the head chips Hc toward the +z direction. The exposure openings 241 are provided independently to the respective head chips Hc. The inks in the form of liquid droplets are ejected in the +z direction from the nozzles 21 that are exposed to the exposure openings 241.

Meanwhile, as described above, the bottom surface of the first recess 231 of the holder 230 is fixed to the head chips Hc in the present embodiment. However, the bottom surface of the first recess 231 of the holder 230 need not be fixed to the head chips Hc. The holder 230 holds the head chips Hc by the intermediary of the cover head 240 even when the bottom surface of the first recess 231 of the holder 230 is not fixed to the head chips Hc. That is to say, the description “the holder 230 holds the head chips Hc” encompasses a configuration in which the holder 230 holds the head chips Hc by being directly fixed thereto, a configuration in which the holder 230 indirectly holds the head chips Hc by the intermediary of the cover head 240 and the second flow channel unit 220 without being directly fixed to the head chips Hc, and so forth.

In the present embodiment, the cover head 240 is an example of a “fixation plate”. Here, a reinforcement plate having a larger thickness than that of the cover head 240 may be provided between the cover head 240 and the holder 230. In this case, the cover head 240 and the reinforcement plate collectively represent an example of the “fixation plate”.

The holder 230 includes a second recess 237 that is provided to a surface of the holder 230 oriented to the −z direction and is open in the −z direction. The second recess 237 has substantially the same size as the first recess 231 and is disposed at a position substantially overlapping the first recess 231 when viewed in the z axis direction. The heaters 260 to heat the ink inside the head chips Hc through the holder 230 are provided on a bottom surface of this second recess 237, which is oriented to the −z direction.

The heaters 260 of the present embodiment are each formed from a film heater. The heaters 260 are disposed on the bottom surface of the second recess 237 of the holder 230 at positions overlapping the two second spaces 233b when viewed in the z axis direction. In the present embodiment, there are provided two heaters 260 in total, which are located at positions overlapping the two second spaces 233b, respectively. Here, in the present embodiment, the first space 233a is disposed at the position interposed between the two second spaces 233b when viewed in the z axis direction as described above. Accordingly, the first space 233a is disposed at the position interposed between the two heaters 260 as a consequence of disposing the heaters 260 at the positions overlapping the second spaces 233b. That is to say, the head chips Hc housed in the first space 233a are disposed at positions interposed between the two heaters 260. The head chips Hc can therefore be efficiently heated with the two heaters 260.

Here, the two heaters 260 are line-symmetrically disposed with respect to an axis extending along the x axis direction as the center when viewed in the z axis direction. In this way, it is possible to reduce costs by using the heater 260 of one type without having to form two different types of the heaters 260 separately.

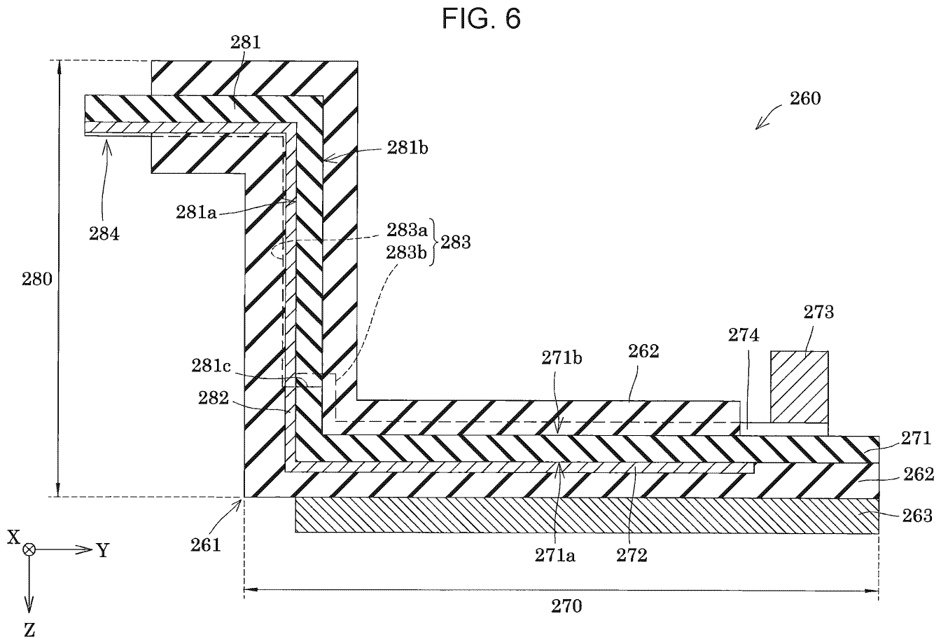

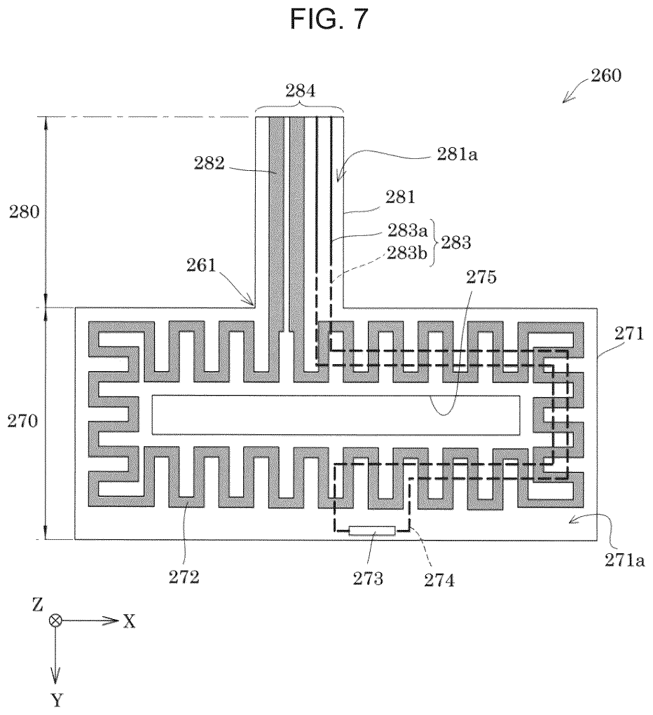

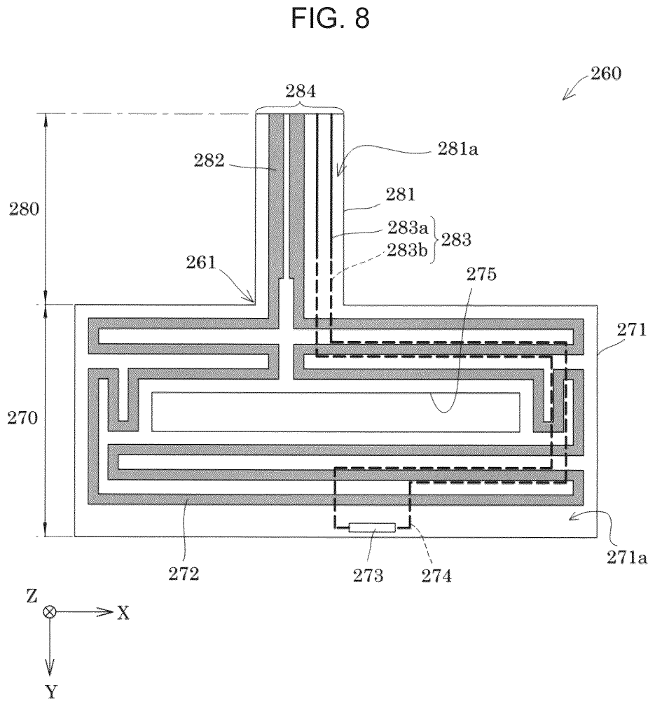

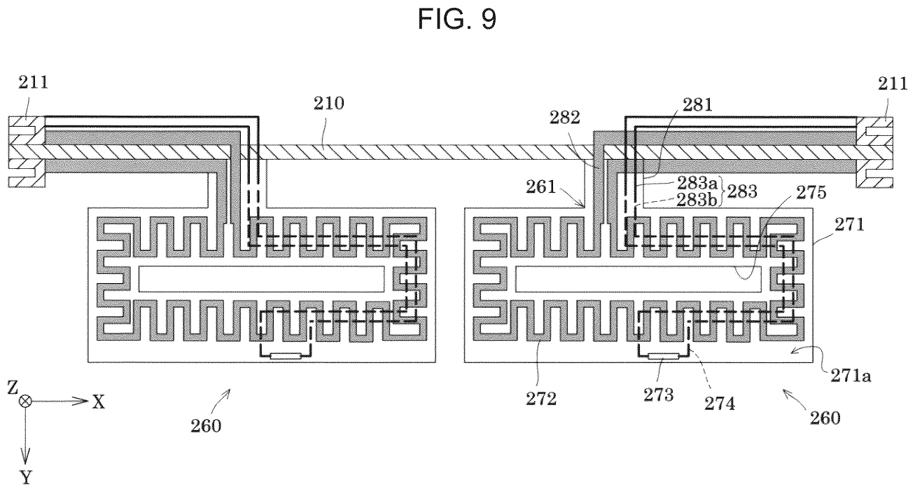

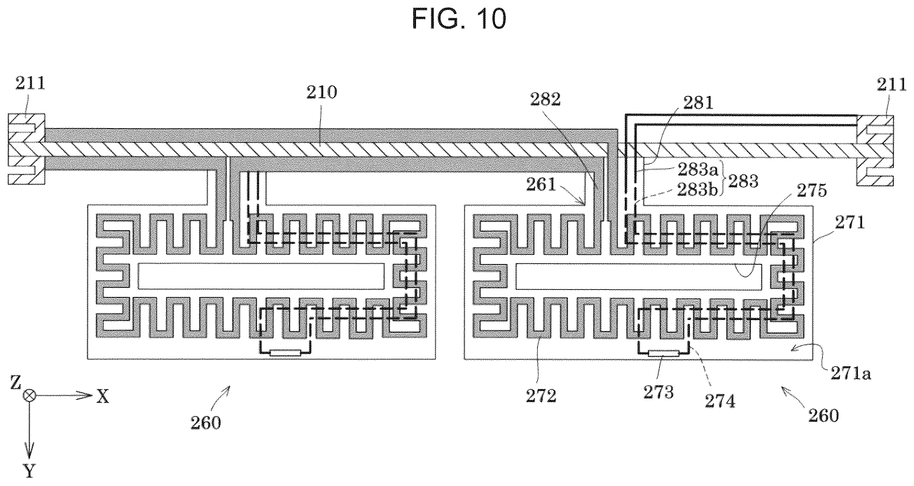

FIG. 6 is a cross-sectional view of each heater 260. FIG. 7 is a plan view of the heater 260 before bending a main surface portion 270 and the lead-out wiring portion 280 thereof. FIG. 8 is a plan view of a modified example of the heater 260 before bending the main surface portion 270 and the lead-out wiring portion 280 thereof. FIG. 9 is a schematic configuration diagram illustrating wiring on the heaters 260 and the relay substrate 210. FIG. 10 is a schematic configuration diagram illustrating a modified example of the wiring on the heaters 260 and the relay substrate 210.

As illustrated in FIGS. 6 and 7, the heater 260 includes the main surface portion 270 and the lead-out wiring portion 280.

The main surface portion 270 includes a first base member 271, a resistance wire 272, a temperature detection element 273, and relay wiring 274.

The first base member 271 is formed from an insulative sheet such as polyimide. The first base member 271 has a first surface 271a and a second surface 271b on the opposite side of the first surface 271a. The above-described first base member 271 has a thickness equal to 25 μm, for example.

The first base member 271 is provided with a communication hole 275 that communicates with the second wiring insertion holes 236 of the holder 230. The communication hole 275 is annularly formed when viewed in the z axis direction.

The resistance wire 272 is preferably an electrically heating wire which is formed from a metal having electrical resistivity of 1.00×10⁻⁶ Ω·m at 20° C. Examples of the electrically heating wire include a nichrome wire formed from a nickel-chromium alloy, a Kanthal wire formed from an iron-chromium-aluminum alloy, and the like. Here, the resistance wire 272 may be formed from stainless steel (SUS) having slightly lower electrical resistivity than that of the electrically heating wire, or from copper (Cu) having lower electrical resistivity than that of the electrically heating wire. The above-described resistance wire 272 is provided on the first surface 271a of the first base member 271. As illustrated in FIG. 7, the resistance wire 272 is provided in a meandering manner over a circumferential direction of the annular first base member 271 when viewed in the z axis direction. Alternatively, the resistance wire 272 may be provided in a linearly folded manner along the circumferential direction as illustrated in FIG. 8. That is to say, in any of the cases in FIGS. 7 and 8, the resistance wire 272 are annularly formed over the circumferential direction of the communication hole 275.

A cross-sectional area of the above-described resistance wire 272 is determined by defining its width and thickness so as to obtain the electric resistivity that provides the holder 230 with an optimum heat quantity. In the case of forming the resistance wire 272 from copper (Cu), for example, the resistance wire 272 may be formed into an elongate shape since copper has the lower electric resistivity than that of the electrically heating wire. The thickness of the above-mentioned resistance wire 272 is set equal to 12 μm, for example.

The temperature detection element 273 is formed from a thermistor or a temperature measuring resistor, for example, and is provided on the second surface 271b side of the first base member 271. In the meantime, the temperature detection element 273 is disposed at such a position that does not overlap the resistance wire 272 when viewed in the z axis direction being the thickness direction of the first base member 271. In the present embodiment, the temperature detection element 273 is provided at an end portion of the first base member 271 and the resistance wire 272 is not provided at the end portion of the first base member 271. Accordingly, the temperature detection element 273 and the resistance wire 272 do not overlap each other in the z axis direction. By disposing the temperature detection element 273 at the position not overlapping the resistance wire 272 when viewed in the z axis direction, the temperature detection element 273 is caused to detect a temperature of the holder 230 being a heat transfer target without causing the temperature detection element 273 to detect an instantaneous increase in temperature of the resistance wire 272. Hence, the temperature detection element 273 can measure the temperature of the holder 230 more accurately.

Meanwhile, the temperature detection element 273 is disposed on an outer side of the annularly provided resistance wire 272, or in other words, on an opposite side of the communication hole 275 of the resistance wire 272. Even when the temperature detection element 273 is disposed at the position on the holder 230 close to the head chips Hc by disposing the temperature detection element 273 on the outer side of the resistance wire 272 in order to detect the temperature of the head chips Hc at high accuracy with the temperature detection element 273, it is possible to avoid an increase in size of the main surface portion 270 by disposing the resistance wire 272 and the relay wiring 274 in such a way as to overlap each other when viewed in the z axis direction.

The relay wiring 274 is provided on the second surface 271b of the first base member 271 and is electrically connected to the temperature detection element 273. Meanwhile, the relay wiring 274 overlaps the resistance wire 272 when viewed in the z axis direction. Here, the description “the relay wiring 274 overlaps the resistance wire 272 when viewed in the z axis direction” means that the relay wiring 274 and the resistance wire 272 overlap each other at least partially. By providing the relay wiring 274 and the resistance wire 272 on different surfaces of the first base member 271 as described above, it is possible to downsize the main surface portion 270 of the heater 260 as compared to the case of providing the relay wiring 274 and the resistance wire 272 on the same surface. Moreover, the main surface portion 270 of the heater 260 can further be downsized by disposing the relay wiring 274 and the resistance wire 272 at the overlapping positions when viewed in the z axis direction. Meanwhile, as illustrated in FIG. 7, directions of extension of the relay wiring 274 and the resistance wire 272 are preferably set to different directions from each other when viewed in the z axis direction. By causing the relay wiring 274 and the resistance wire 272 having the different directions of extension to cross each other, it is possible to keep the relay wiring 274 from being affected by noise caused by on-off control of the resistance wire 272, power control using semiconductor or so-called PWM control, and the like, thereby improving measurement accuracy of the temperature detection element 273. Alternatively, as illustrated in FIG. 8, the directions of extension of the relay wiring 274 and the resistance wire 272 may be set to the same direction when viewed in the z axis direction. By setting the directions of extension of the relay wiring 274 and the resistance wire 272 to the same direction as described above, it is possible to extend the resistance wire 272 in a planar direction. Thus, heat is likely to be transferred in the planar direction by the intermediary of the resistance wire 272. That is to say, since the heat generated by the resistance wire 272 can be transferred in the planar direction through the first base member 271 and the resistance wire 272 itself, so that the holder 230 can be heated in a wider area in a state of relatively less unevenness in temperature. The thickness of the above-mentioned relay wiring 274 is set equal to 12 μm, for example.

The lead-out wiring portion 280 is connected to the main surface portion 270 at a connection portion 261. The lead-out wiring portion 280 is bent substantially by 90 degrees from the main surface portion 270. Meanwhile, the lead-out wiring portion 280 includes an insulative second base member 281 provided continuously with the first base member 271. That is to say, the first base member 271 and the second base member 281 are formed by bending a continuous base member substantially by 90 degrees. Here, the second base member 281 includes a third surface 281a provided continuously with the first surface 271a of the first base member 271, and a fourth surface 281b provided continuously with the second surface 271b of the first base member 271.

Moreover, the lead-out wiring portion 280 includes first lead-out wiring 282 and second lead-out wiring 283.

The first lead-out wiring 282 is electrically connected to the resistance wire 272. The first lead-out wiring 282 is provided on the third surface 281a of the second base member 281. The first lead-out wiring 282 extends in a direction crossing the first base member 271. Here, the description “direction crossing the first base member 271” is a direction crossing a planar direction of the first base member 271, which includes a perpendicular direction to the first base member 271 and a direction inclined with respect to the perpendicular direction.

The second lead-out wiring 283 is electrically connected to the relay wiring 274. As with the first lead-out wiring 282, the second lead-out wiring 283 extends in the direction crossing the first base member 271.

The second lead-out wiring 283 includes a first portion 283a that is provided on the third surface 281a, and a second portion 283b that is electrically connected to the first portion 283a via inside of a through hole 281c penetrating the second base member 281 and is provided on the fourth surface 281b. That is to say, the first portion 283a provided on the third surface 281a is electrically connected to the second portion 283b provided on the fourth surface 281b via the through hole 281c penetrating the second base member 281. By leading out a portion of the second lead-out wiring 283 to the fourth surface 281b via the through hole 281c provided to the second base member 281 in the configuration to lead out the second lead-out wiring 283 and the resistance wire 272 to the same fourth surface 281b, it is possible to heat the resistance wire 272 efficiently by feeding a relatively large current to the resistance wire 272 without having to lead out the resistance wire 272 to the fourth surface 281b via a through hole.

It is preferable to use a material with as low electrical resistivity as possible as the first lead-out wiring 282, the second lead-out wiring 283, and the relay wiring 274. For example, one or a combination of two or more elements selected from silver (Ag), copper (Cu), gold (Au), aluminum (Al), platinum (Pt), and tin (Sn) can be used as the aforementioned material. Meanwhile, the first lead-out wiring 282, the second lead-out wiring 283, and the relay wiring 274 do not have a meandering portion in comparison with the resistance wire 272. Moreover, no circuit elements or the like can be provided in the middle of the resistance wire 272, whereas such circuit elements and the like can be provided in the middle of the first lead-out wiring 282, the second lead-out wiring 283, and the relay wiring 274. In addition, a cross-sectional area of each of the first lead-out wiring 282, the second lead-out wiring 283, and the relay wiring 274 is smaller than that of the resistance wire 272.

At an end portion of the lead-out wiring portion 280 including these elements on the opposite side of the connection portion 261, there is provided a connection terminal portion 284 which is a portion to expose the first lead-out wiring 282 and the second lead-out wiring 283 to outside without being covered with a cover layer 262 to be described later. The connection terminal portion 284 is inserted into the second through hole 213 of the relay substrate 210, thereby being led out on the −z side of the relay substrate 210 and electrically connected to a surface of the relay substrate 210 oriented to the −z direction. Connection between the relay substrate 210 and the lead-out wiring portion 280 may adopt soldering and brazing, welding, attachment with a conductive adhesive, and so forth.

Meanwhile, as illustrated in FIG. 9, the two heaters 260 may be wired independently of each other on the relay substrate 210. In the meantime, the temperature detection elements 273 of the two heaters 260 are used one by one. That is to say, two sets of the relay wiring 274 of the temperature detection elements 273 of the two heaters 260 are wired to reach the connectors 211, respectively. By independently wiring the two heaters 260 on the relay substrate 210 as described above, it is possible to control the two heaters 260 independently of each other so that highly accurate temperature control can be carried out while suppressing unevenness in temperature distribution in the holder 230.

Alternatively, the two heaters 260 may be serially wired on the relay substrate 210 as illustrated in FIG. 10. The resistance wire 272 of one of the heaters 260 and the resistance wire 272 of the other heater 260 may be connected in series on the relay substrate 210. In this case, the temperature detection element 273 of the one heater 260 may be used while not using the temperature detection element 273 of the other heater 260. That is to say, the relay wiring 274 of the temperature detection element 273 of the one heater 260 may be wired to the connector 211 while not wiring the relay wiring 274 of the temperature detection element 273 of the other heater 260 to the connector 211. By connecting the two heaters 260 in series on the relay substrate 210 as described above, it is possible to carry our control of the heaters 260 easily without having to carry out individual control of the two heaters 260.

Here, when viewed in the z axis direction, the resistance wire 272 is disposed between the temperature detection element 273 and the connection portion 261 that connects the main surface portion 270 to the lead-out wiring portion 280. Even in the case of the above-mentioned configuration in which the resistance wire 272 is disposed between the connection portion 261 and the temperature detection element 273, it is possible to realize routing of the resistance wire 272 and the relay wiring 274 in such a way as not to cause an increase in size of the main surface portion 270 since the resistance wire 272 overlaps the relay wiring 274 when viewed in the z axis direction.

Meanwhile, the temperature detection element 273 is disposed at a position closer to the nozzle 21 than the connection portion 261 is. By providing the temperature detection element 273 at the position closer to the nozzle 21 as described above, the temperature detection element 273 can detect the temperature on the nozzle 21 side relatively at high accuracy. While the heater 260 tends to be relatively increased in size, disposition of the connection portion 261 at a position farther from the nozzle 21 makes it unnecessary to secure a space for routing the resistance wire 272 and the relay wiring 274 on the same surface by routing the resistance wire 272 and the relay wiring 274 on different surfaces instead. Thus, it is possible to suppress an increase in size of the heater 260.

Here, each of the surface that is oriented to the first surface 271a, the surface that is oriented to the third surface 281a, the surface that is oriented to the second surface 271b, and the surface that is oriented to the fourth surface 281b of the main surface portion 270 and of the lead-out wiring portion 280 is provided with the cover layer 262. The cover layer 262 is formed from an insulative sheet of polyimide resin and the like. A thickness of the cover layer 262 is set equal to 30 μm, for example.

A surface of the main surface portion 270 of the heater 260 described above, which is oriented to the same direction as the direction to which the first surface 271a is oriented, is fixed to the holder 230 being a heating target. By fixing the surface oriented to the same direction as is the first surface 271a of the main surface portion 270 and being provided with the resistance wire 272 to the holder 230 as described above, it is possible to transfer the heat efficiently from the resistance wire 272 to the holder 230. Of course, the surface of the main surface portion 270 oriented to the direction to which the second surface 271b is oriented may be fixed to the holder 230. However, the heat from the resistance wire 272 will be transferred to the holder 230 through the first base member 271 in this case, and heat transfer efficiency will therefore be deteriorated. Note that the method of fixing the heater 260 to the holder 230 is not limited to a particular method. Examples of such a method include attachment by using an adhesive, use of a double-sided tape, and the like. In the present embodiment, the heater 260 is fixed to the holder 230 by using a double-sided tape 263. A thickness of the double-sided tape 263 is set equal to 50 μm, for example.

Here, as illustrated in FIG. 4, the heater 260 is disposed at such a position that an area S1 of a portion of the heater 260 which overlaps the housing space 233 and does not overlap the head chip Hc becomes larger than an area S2 of a region of the heater 260 overlapping the head chip Hc when viewed in the z axis direction. The area S2 is region of the heater 260 indicated with a dash-dotted line in FIG. 4, which is the region of the portion where the heater 260 overlaps the housing space 233 except the area S1. As mentioned above, the heater 260 is disposed at such a position that makes the area S1 larger than the area S2. That is to say, in the case where a dummy second space 233b where the head chip Hc is not disposed is present in the housing space 233, the heater 260 can be installed easily by disposing the heater 260 by using this second space 233b. Instead, the heater 260 may be disposed at a position where the heater 260 does not overlap the head chip Hc at all when viewed in the z axis direction.

The above-described heater 260 heats the ink inside the head chip Hc through the holder 230. Here, the heat from the heater 260 is transferred to the cover head 240 through the outer peripheral wall portion 232 and the partition wall portions 234 of the holder 230. The heat transferred to the cover head 240 is further transferred to the communication plate 15 through the compliance substrate 45, and the heat transferred to the communication plate 15 is further transferred to the nozzle plate 20, the flow channel formation substrate 10, the case member 40, and the like. Here, the cover head 240 is made of a metal having high thermal conductivity. Accordingly, the heat of the holder 230 is easily transferred to the head chip Hc through the cover head 240.

Meanwhile, the case member 40 of the head chip Hc is directly fixed to the holder 230 in the present embodiment. Accordingly, the heat is directly transferred from the holder 230 to the case member 40 of the head chip Hc. Moreover, the head chip He is housed in the housing space 233 of the holder 230 and its outer periphery except that in the +z direction is covered with the holder 230. For this reason, the heat of the holder 230 heated by the heater 260 is transferred to the entire head chip Hc through an atmosphere in the housing space 233. The ink inside the head chip Hc is heated by causing the heater 260 to heat the head chip Hc through the holder 230.

Here, the control unit 4 controls the heating of the holder 230 by the heater 260 based on the temperature detected by the temperature detection element 273. In the present embodiment, by disposing the temperature detection element 273 at the position not overlapping the resistance wire 272 when viewed in the z axis direction as described above, it is possible to cause the temperature detection element 273 to detect the temperature of the holder 230 being the heat transfer target without causing the temperature detection element 273 to detect an instantaneous increase in temperature of the resistance wire 272 if the case arises. As a consequence, the temperature detection element 273 can measure the temperature of the holder 230 more accurately so that the holder 230 can be heated to a target temperature at high accuracy by using the heater 260.

Note that the lead-out wiring portion is an example of a “second flexible substrate” in the present embodiment.

Here, in the case of an attempt to eject a highly viscous liquid from the liquid ejecting head H at a low temperature environment applicable to an ultraviolet curable ink and the like, it is difficult to eject the liquid from the nozzles 21 in the state where the viscosity of the liquid is high. For this reason, the viscosity needs to be reduced by heating the liquid in the liquid ejecting head H by using the above-described heater 260. It is therefore preferable to form the holder 230 being the heating target with the heater 260 by using a material having high thermal conductivity such as a metal and a ceramic. Nonetheless, it is very costly to form the intricately shaped holder 230 by using the material such as a metal and a ceramic. Accordingly, it is desirable to form the holder 230 by using a resin material at low costs. However, the holder 230 formed from a resin has low thermal conductivity. Hence, there is a problem of incapability of sufficiently heating the liquid inside the liquid ejecting head H by using the heater 260.

Given the circumstances, the holder 230 of the present embodiment is formed from a thermally conductive resin. The thermally conductive resin represents a resin provided with thermal conductivity by causing a resin matrix to contain a thermally conductive filler. Formation of the holder 230 from the thermally conductive resin makes it possible to facilitate production while reducing costs as compared to formation from the metal or the ceramic, and to efficiently heat the ink in the head chip Hc through the holder 230 by using the heater 260. Moreover, the holder 230 does not define any flow channels. Accordingly, even when the holder 230 is formed from the thermally conductive resin, it is possible to prevent the thermally conductive filler that falls off the resin material from being mixed into the ink in a flow channel. Accordingly, it is possible to reduce a risk of clogging the nozzles 21 with the thermally conductive filler that would fall off and cause an ejection failure.

Here, it is possible to appropriately select and adopt an arbitrary one of publicly known thermoplastic resins as the resin matrix to be used in the thermally conductive resin, for instance. Examples of the aforementioned thermoplastic resins include a polyolefin-based resin such as polyethylene and polypropylene, a polyamide-based resin such as nylon 6, nylon 66, nylon 11, nylon 12, and aromatic polyamide, a polyester-based resin such as polyethylene terephthalate, polybutylene terephthalate, and polycyclohexylmethylene terephthalate, ABS resin, polycarbonate resin, modified polyphenylene ether resin, polyacetal resin, polyphenylenesulfide resin, fully aromatic polyester resin, polyether ether ketone resin, polyethersulfone resin, polysulfone resin, polyamide-imide resin, a copolymer resin formed from two or more structural components of these resins, and the like. It is possible to use only one of these thermoplastic resins or to use a combination of two or more of these thermoplastic resins. In the meantime, it is possible to appropriately select and adopt an arbitrary one of publicly known thermosetting resins as the resin matrix to be used in the thermally conductive resin. Examples of the aforementioned thermosetting resins include phenol resin, polyurethane, epoxy resin, melamine resin, and the like.

The thermally conductive filler to be contained in the above-described resin matrix is not limited to a particular filler as long as the filler has high thermal conductivity, and various types of fillers can therefore be used. Examples of the above-mentioned thermally conductive filler include powder of an oxide such as aluminum oxide (alias alumina), zinc oxide, magnesium oxide, and silicon dioxide, powder of a nitride such as boron nitride, aluminum nitride, and silicon nitride, powder of a metal such as gold, silver, aluminum, iron, and copper, silicon carbide powder, and the like. It is possible to use only one of these highly thermally conductive fillers or to use a combination of two or more of these highly thermally conductive fillers.

When grain sizes of the above-mentioned highly thermally conductive filler are reduced, a viscosity of a compound thereof tends to be significantly increased so as to complicate filling in a filling process. As a consequence, there is a case where a resin material having high thermal conductivity is unavailable. On the other hand, when the grain sizes are increased, gaps between the grains of the thermally conductive filler become narrow and the grains are more likely to come into contact with one another. As a consequence, the thermal conductivity tends to be relatively high because the heat is more likely to be transferred. Particularly, in the present embodiment, the holder 230 does not define any flow channels. Accordingly, even if the thermally conductive filler has the large grain sizes and are more likely to fall off the resin material, the thermally conductive filler that falls off is less likely to be mixed into the inks. For this reason, an average grain size of the thermally conductive filler used in the thermally conductive resin is preferably larger than 80 μm, or more preferably equal to or larger than 90 μm, or even more preferably equal to or larger than 100 μm. By forming the holder 230 from the thermally conductive resin that contains the thermally conductive filler having the average grain size large than the diameter of the nozzles 21 as described above, the thermal conductivity of the holder is set relatively high while keeping the thermally conductive filler from being mixed into the ink. Thus, it is possible to suppress the occurrence of a failure such as clogging of the nozzles 21.

When the thermally conductive filler is not spherical, for example, the average grain size of the thermally conductive filler is obtained by measuring the largest lengths of the grains of the thermally conductive filler and then calculating an average thereof. Meanwhile, the measurement of the thermally conductive filler is carried out by shooting an image of the thermally conductive filler directly or shooting cross-sections thereof in the state of being contained in the thermally conductive resin.

In the meantime, a content of the thermally conductive filler is preferably set larger than 70% by volume relative to a total volume of the holder 230. The thermal conductivity of the holder 230 can be set relatively high by forming the holder 230 while setting the content of the thermally conductive filler larger than 70% by volume as mentioned above. Of course, the content of the thermally conductive filler may be set equal to or below 70% by volume relative to the total volume of the holder 230. In this way, it is possible to improve formability. However, the thermal conductivity of the holder 230 is reduced when the content of the thermally conductive filler is small. For this reason, the content of the thermally conductive filler is preferably set equal to or larger than 30% by volume or more preferably set equal to or larger 50% by volume relative to the total volume of the holder 230.

Meanwhile, additives such as another bulking agent, a flame retardant, a heat resistance improver, and a weather resistance improver can be mixed with the thermally conductive resin material as appropriate. Examples of the other bulking agent include bulking agents having large reinforcing effects such as mica, talc, fibers such as carbon fibers and glass fibers, and whiskers. Here, specific examples of the whiskers include non-oxide whiskers made of silicon carbide, silicon nitride, and the like, metal oxide whiskers made of ZnO, MgO, TiO₂, SnO₂, Al₂O₃, and the like, and multiple oxide whiskers made of potassium titanate, aluminum borate, basic magnesium sulfate, and the like. Among these substances, the multiple oxide whiskers are preferred from the viewpoint of ease of forming a composite with plastics.

In the meantime, in the holder 230, first thermal conductivity concerning the z axis direction being the thickness direction of the heater 260 is larger than second thermal conductivity concerning a direction along the planar direction of the heater 260, that is to say, a direction along the xy plane. Here, the first thermal conductivity is preferably equal to or more than three times the second thermal conductivity.

To put it another way, the first thermal conductivity is thermal conductivity concerning the direction of arrangement of the heater 260, the portion of the holder 230 interposed between the heater 260 and the head chip Hc, and the head chip Hc. In the meantime, the second thermal conductivity is thermal conductivity concerning a direction orthogonal to the aforementioned direction.

To put it still another way, the first thermal conductivity is the thermal conductivity concerning the z axis direction being a direction perpendicular to the surface of the holder 230 oriented to the opposite side of the surface thereof fixed to the cover head 240, or in other words, the surface of the holder 230 on which the heater 260 is disposed. In the meantime, the second thermal conductivity is the thermal conductivity concerning a direction parallel to the surface of the holder 230 on which the heater 260 is disposed.

That is to say, since the heat from the heater 260 is likely to migrate in the holder 230 along the z axis direction, the heater 260 is able to heat the cover head 240 easily. As a consequence, the ink inside the head chip Hc can be heated easily by the heat transfer from the cover head 240 to the head chip Hc.

The thermally conductive resin according to the present embodiment is characterized in that one or more of the thermal conductivity in the z axis direction and the thermal conductivity in the direction along the xy plane is equal to or above 1.0 W/m·K. This value is preferably equal to or above 2.0 W/m·K, or more preferably equal to or above 10 W/m·K, or even more preferably equal to or above 20 W/m·K.

The thermal conductivity according to the present embodiment can be measured in accordance with a method that complies with JIS-A-1412. Examples of a specific measurement apparatus include a thermophysical measurement device TPA-501 (manufactured by Kyoto Electronics Manufacturing Co., Ltd.) adopting the Hot Disk method, and the like. Otherwise, the thermal conductivity may be measured in accordance with the flash method.

In the meantime, the thermally conductive resin is preferably a conductive resin material.

On the other hand, the second flow channel unit 220 is formed from a resin that does not contain a thermally conductive filler. Here, a substance that “does not contain the thermally conductive filler” in the present embodiment includes a substance that does not contain the thermally conductive filler at all and a substance that contains a thermally conductive filler insofar as its thermal conductivity is below 1.0 W/m·K. That is to say, in the present embodiment, a substance is regarded as the substance that does not contain the thermally conductive filler when its thermal conductivity is below 1.0 W/m·K. By using the resin material that does not contain the thermally conductive filler as the second flow channel unit 220 for defining the flow channels as mentioned above, it is possible to keep the thermally conductive filler from falling off the second flow channel unit 220 and being mixed into the ink, and thus to perform stable ejection while suppressing the occurrence of a variation in state of ejection of ink droplets.

Note that the first flow channel unit 200 is formed from a material that does not contain a thermally conductive filler as with the second flow channel unit 220.

By forming the first flow channel unit 200 and the second flow channel unit 220 from the resin material that does not contain the thermally conductive filler as described above, it is possible to keep the thermally conductive filler from falling in the flow channels.

### Other Embodiments

A certain embodiment of the present disclosure has been described above. It is to be noted, however, that the basic structure of the present disclosure is not limited to the above-described configuration.

For example, the liquid ejecting head H includes the two head chips Hc in the above-described Embodiment 1. However, the present disclosure is not limited to this configuration. The liquid ejecting head H may include one head chip Hc or three or more head chips Hc.

Meanwhile, the two heaters 260 are provided in the above-described Embodiment 1. However, the present disclosure is not limited to this configuration, and a single heater formed from a continuous base member may be provided instead. When there are spaces on two sides in the x axis direction of the second wiring insertion holes 236 of the second recess 237, the heater may be designed to be continuously provided in these spaces. On the other hand, when there are no spaces on two sides in the x axis direction of the second wiring insertion holes 236 of the second recess 237, the heater may be continuously provided by bending a portion of the heater along a wall surface of the second recess 237.

In the meantime, the above-described Embodiment 1 exemplifies the configuration in which the holder 230 is provided with the second spaces 233b. However, the present disclosure is not limited to this configuration, and each second space 233b may be buried with a resin. However, a thick portion of a resin product is generally prone to develop a so-called “sink”, which is a depression that appears on a surface due to contraction when the resin is cooled down and hardened in a molding process. In this regard, provision of the second spaces 233b to the holder 230 suppresses such sinks at the time of molding and enables manufacturing of a product at high precision.

In the meantime, the lead-out wiring portion 280 is provided as a portion of the heater 260 in the above-described Embodiment 1. However, the present disclosure is not limited to this configuration. The lead-out wiring portion 280 does not have to be a portion of the heater 260. That is to say, in the above-described Embodiment 1, the first base member 271 of the main surface portion 270 and the second base member 281 of the lead-out wiring portion 280 are integrally formed by bending the same base member. However, the present disclosure is not limited to this configuration, and the main surface portion and the lead-out wiring portion being separate members may be electrically connected and integrated together instead. That is to say, the heater may be formed only from the main surface portion, and the lead-out wiring portion is not designed to constitute a portion of the heater. Electrical connection between the main surface portion and the lead-out wiring portion may adopt soldering, connection using a conductive adhesive (ACP) and the like, or connection by using a connector.

In addition, the holder 230 is formed from the thermally conductive resin in the above-described Embodiment 1. However, the present disclosure in not limited to this configuration, and the holder 230 may be formed from a metal or a ceramic having high thermal conductivity.

### Supplements

For example, the following configurations are figured out from the embodiment exemplified above.

A liquid ejecting head according to aspect 1 as preferable aspect includes: a nozzle that ejects a liquid; and a sheet-shaped heater for heating the liquid to be supplied to the nozzle, and the heater includes a main surface portion having a temperature detection element, an insulative first base member having a first surface and a second surface on an opposite side of the first surface, a resistance wire disposed on the first surface and configured to heat a heating target being a portion of the liquid ejecting head, and relay wiring electrically connected to the temperature detection element and disposed on the second surface, and the resistance wire overlaps the relay wiring when viewed in a thickness direction of the main surface portion. According to this aspect, by providing the resistance wire and the relay wiring on the different surfaces from each other, it is possible to downsize the heater as compared to the case of providing the resistance wire and the relay wiring on the same surface. Moreover, it is possible to further downsize the heater by disposing the resistance wire and the relay wiring at the positions overlapping each other when viewed in the thickness direction.

In aspect 2 as specific example of the aspect 1, the temperature detection element does not overlap the resistance wire when viewed in the thickness direction. According to this aspect, by disposing the temperature detection element at the position not overlapping the resistance wire when viewed in the z axis direction, the temperature detection element is caused to detect the temperature of the heat transfer target without causing the temperature detection element to detect the temperature in case of an instantaneous increase in temperature of the resistance wire. Thus, the temperature detection element can more accurately measure the temperature of the heat transfer target.

In aspect 3 as specific example of the aspect 1, the liquid ejecting head further includes: a lead-out wiring portion including first lead-out wiring being electrically connected to the resistance wire and extending in a direction crossing the first base member, and second lead-out wiring being electrically connected to the relay wiring and extending in a direction crossing the first base member, and the resistance wire is disposed between a connection portion to connect the main surface portion to the lead-out wiring portion and the temperature detection element when viewed in the thickness direction. According to this aspect, even in the configuration to dispose the resistance wire between the connection portion and the temperature detection element, it is possible to route the resistance wire and the relay wiring in such a way as not to increase the main surface portion in size by causing the resistance wire and the relay wiring to overlap each other when viewed in the thickness direction.

In aspect 4 as specific example of the aspect 3, the lead-out wiring portion is a portion of the heater bent from the main surface portion, and includes an insulative second base member provided continuously with the first base member, the second base member includes a third surface provided continuously with the first surface, and a fourth surface provided continuously with the second surface, and the second lead-out wiring includes a first portion that is provided on the third surface together with the first lead-out wiring, and a second portion that is electrically connected to the first portion via a through hole penetrating the second base member, and is provided on the fourth surface. According to this aspect, in the configuration to lead out the second lead-out wiring and the resistance wire to the same fourth surface, it is not necessary to lead out the resistance wire to the fourth surface via the through hole by leading out a portion of the second lead-out wiring to the fourth surface via the through hole provided to the second base member. Thus, it is possible to heat the resistance wire efficiently by feeding a relatively large current to the resistance wire.

In aspect 5 as specific example of the aspect 3, the temperature detection element is disposed closer to the nozzle than the connection portion is when viewed in the thickness direction. According to this aspect, it is possible to detect the temperature on the nozzle side by disposing the temperature detection element close to the nozzle. Meanwhile, the heater is likely to become relatively large as a consequence of disposing the connection portion at a position far from the position of the nozzle. Nonetheless, it is not necessary to secure a space for routing the resistance wire and the relay wiring on the same surface by routing the resistance wire and the relay wiring on the surfaces different from each other instead. Thus, it is possible to suppress an increase in size of the heater.

In aspect 6 as specific example of the aspect 1, the temperature detection element is disposed on an outer side of the resistance wire when viewed in the thickness direction. According to this aspect, the temperature detection element is disposed on the outer side of the resistance wire in order to detect the temperature of the head chip accurately with the temperature detection element. In this regard, even when the temperature detection element is disposed close to the head chip of the holder, it is possible to avoid an increase in size of the main surface portion by disposing the resistance wire and the relay wiring in such a way as to overlap each other when viewed in the thickness direction.

In aspect 7 as specific example of the aspect 1, a surface of the main surface portion being oriented to a direction coinciding with a direction to which the first surface is oriented is fixed to the heating target. According to this aspect, the resistance wire can efficiently heat the heat transfer target by fixing the surface in the direction to which the first surface provided with the resistance wire is oriented to the heat transfer target.

A liquid ejecting apparatus according to aspect 8 as preferable aspect includes: the liquid ejecting head according to aspect 1; and a liquid reservoir that reserves the liquid to be supplied to the liquid ejecting head.

According to this aspect, the liquid inside the liquid ejecting head can be heated by the heater, and the liquid ejecting head and the liquid ejecting apparatus can be downsized by downsizing the heater.

What is claimed is:

1. A liquid ejecting head comprising:
a nozzle configured to eject a liquid; and
a sheet-shaped heater configured to heat the liquid to be supplied to the nozzle, wherein
the heater includes a main surface portion having
a temperature detection element,
an insulative first base member having a first surface and a second surface that is opposite from the first surface,
a resistance wire disposed on the first surface and configured to heat a heating target being a portion of the liquid ejecting head, and
relay wiring electrically connected to the temperature detection element and disposed on the second surface, and
the resistance wire overlaps the relay wiring when viewed in a thickness direction of the main surface portion.

2. The liquid ejecting head according to claim 1, wherein the temperature detection element does not overlap the resistance wire when viewed in the thickness direction.

3. The liquid ejecting head according to claim 1, further comprising:
a lead-out wiring portion including
first lead-out wiring being electrically connected to the resistance wire and extending in a direction crossing the first base member, and
second lead-out wiring being electrically connected to the relay wiring and extending in a direction crossing the first base member, and
the resistance wire is disposed between a connection portion to connect the main surface portion to the lead-out wiring portion and the temperature detection element when viewed in the thickness direction.

4. The liquid ejecting head according to claim 3, wherein
the lead-out wiring portion is a portion of the heater bent from the main surface portion, and includes an insulative second base member provided continuously with the first base member,
the second base member includes a third surface provided continuously with the first surface, and a fourth surface provided continuously with the second surface, and
the second lead-out wiring includes
a first portion that is provided on the third surface together with the first lead-out wiring, and
a second portion that is electrically connected to the first portion via a through hole penetrating the second base member, and is provided on the fourth surface.

5. The liquid ejecting head according to claim 3, wherein the temperature detection element is disposed closer to the nozzle than is the connection portion is when viewed in the thickness direction.

6. The liquid ejecting head according to claim 1, wherein the temperature detection element is disposed on an outer side of the resistance wire when viewed in the thickness direction.

7. The liquid ejecting head according to claim 1, wherein a surface of the main surface portion facing a direction that the first surface faces is fixed to the heating target.

8. A liquid ejecting apparatus comprising:
the liquid ejecting head according to claim 1; and
a liquid reservoir that reserves the liquid to be supplied to the liquid ejecting head.
